(19) United States
(12) Patent Application Publication
(10) Pub. No.: US 2021/0010522 A1
(43) Pub. Date: Jan. 14, 2021

(54) CONNECTION STRUCTURE OF INTERNAL THREAD OF DUMBELL-LIKE SHAPED SYMMETRICAL BIDIRECTIONAL TAPERED THREAD AND TRADITIONAL THREAD

(71) Applicant: AMICUS VERITATIS MACHINERY CO., LTD., TAIZHOU (CN)

(72) Inventor: Yihua YOU, TAIZHOU (CN)

(21) Appl. No.: 17/036,655

(22) Filed: Sep. 29, 2020

Related U.S. Application Data
(63) Continuation of application No. PCT/CN2019/081398, filed on Apr. 4, 2019.

(30) Foreign Application Priority Data
Apr. 7, 2018 (CN) 201810303092.9

(51) Int. Cl. F16B 35/04

(52) U.S. Cl. CPC F16B 35/041

(57) ABSTRACT

The invention belongs to the field of general technology of device, and relates to a connection structure of an internal thread of a dumbbell-like shaped symmetrical bidirectional tapered thread and a traditional thread, which solves the problem of poor self-positioning and self-locking of existing threads. An internal thread (6) is a dumbbell-like shaped bidirectional tapered hole (41) (non-entity space) helically distributed on an inner surface of a cylindrical body (2), with a complete unit thread having a left taper (95) same as and/or approximately same as a right taper (96), and has an ability to assimilate a traditional external thread (9); and the traditional external thread (9) after assimilation is a helical special tapered body (7) on an outer surface of a columnar body (3).

### CROSS-REFERENCE TO RELATED APPLICATIONS

This application is a continuation of International Patent Application No. PCT/CN2019/081398 with a filing date of Apr. 4, 2019, designating the United States, now pending, and further claims priority to Chinese Patent Application No. 201810303092.9 with a filing date of Apr. 7, 2018. The content of the aforementioned applications, including any intervening amendments thereto, are incorporated herein by reference.

### TECHNICAL FIELD

The present invention belongs to the field of general technology of device, and particularly relates to a connection structure of an internal thread of a dumbbell-like shaped symmetrical bidirectional tapered thread and a traditional thread (hereinafter referred to as “the bidirectional tapered internal thread and traditional thread”).

### BACKGROUND OF THE INVENTION

The invention of thread has a profound impact on the progress of human society. Thread is one of the most basic industrial technologies. It is not a specific product, but a key generic technology in the industry. It has the technical performance that must be embodied by specific products as application carriers, and is widely applied in various industries. The existing thread technology has high standardization level, mature technical theory and long-term practical application. It is a fastening thread when used for fastening, a sealing thread when used for sealing, and a transmission thread when used for transmission. According to the thread terminology of national standards, “thread” refers to a tooth body with the same thread form and continuously raising along a helical line on a cylindrical or conical surface; and “tooth body” refers to a material entity between adjacent flanks. This is also the definition of thread under global consensus.

Modern threads began in 1841 with Whitworth thread in England. According to the theory of modern thread technology, the basic condition for self-locking of the thread is that an equivalent friction angle shall not be smaller than a helix angle. This is an understanding for the thread technology in modern thread based on a technical principle—“principle of inclined plane”, which has become an important theoretical basis of the modern thread technology. Simon Stevin was the first to explain the principle of inclined plane theoretically. He has researched and discovered the parallelogram law for balancing conditions and force composition of objects on the inclined plane. In 1586, he put forward the famous law of inclined plane that the gravity of an object placed on the inclined plane in the direction of inclined plane is proportional to the sine of inclination angle. The inclined plane refers to a smooth plane inclined to a horizontal plane, a helix is the deformation of the “inclined plane”, and a thread is like the inclined plane wrapped outside a cylinder. The flatter the inclined plane is, the greater a mechanical benefit is (see FIG. 7) (Yang Jingshan, Wang Xiuya, “Discussion on the Principle of Screw”, “Research on Gauss Arithmetic”).

The “principle of inclined plane” of the modern thread is an inclined plane slider model (see FIG. 8) which is established based on the law of inclined plane. It is believed that the thread pair meets the requirements of self-locking when a thread rise angle is less than or equal to the equivalent friction angle under the condition of little change of static load and temperature. The thread rise angle (see FIG. 9), also known as thread lead angle, is an angle between a tangent line of a helical line on a pitch-diameter cylinder and a plane perpendicular to a thread axis; and the angle affects the self-locking and anti-loosening of the thread. The equivalent friction angle is a corresponding friction angle when different friction forms are finally transformed into the most common inclined plane slider form. Generally, in the inclined plane slider model, when the inclined plane is inclined to a certain angle, the friction force of the slider at this time is exactly equal to the component of gravity along the inclined plane; the object is just in a state of force balance at this time; and the inclination angle of the inclined plane at this time is called the equivalent friction angle.

American engineers invented the wedge thread in the middle of last century; and the technical principle of the wedge thread still follows the “principle of inclined plane”. The invention of the wedge thread was inspired by the “wooden wedge”. Specifically, the wedge thread has a structure that a wedge-shaped inclined plane forming an angle of 25°-30° with the thread axis is located at the root of internal threads (i.e., nut threads) of triangular threads (commonly known as common threads); and a wedge-shaped inclined plane of 30° is adopted in engineering practice. For a long time, people have studied and solved the anti-loosening and other problems of the thread from the technical level and technical direction of thread profile angle. The wedge thread technology is also a specific application of the inclined wedge technology without exception.

However, the existing threads have the problems of low connection strength, weak self-positioning ability, poor self-locking performance, low bearing capacity, poor stability, poor compatibility, poor reusability, high temperature and low temperature and the like. Typically, bolts or nuts using the modern thread technology generally have the defect of easy loosening. With the frequent vibration or shaking of equipment, the bolts and the nuts become loose or even fall off, which easily causes safety accidents in serious cases.

### SUMMARY OF THE INVENTION

Any technical theory has theoretical hypothesis background; and the thread is not an exception. With the development of science and technology, the damage to connection is not simple linear load, static or room temperature environment; and linear load, nonlinear load and even the superposition of the two cause more complex load damaging conditions and complex application conditions. Based on such recognition, the object of the present invention is to provide a connection structure of an internal thread of a dumbbell-like shaped symmetrical bidirectional tapered thread and a traditional thread with the advantages of reasonable design, simple structure, and excellent connection performance and locking performance with respect to the above problems.

To achieve the above object, the following technical solution is adopted in the present invention: the connection structure of the internal thread of the dumbbell-like shaped symmetrical bidirectional tapered thread and the traditional thread refers to a special thread pair technology combining technical characteristics of a cone pair and a helical movement, and a thread connection pair formed by an internal thread of a symmetrical bidirectional tapered thread and an external thread of a traditional thread is used. The internal thread of the bidirectional tapered thread refers to a thread technology combining technical characteristics of a bidirectional tapered body and a helical structure. The bidirectional tapered body is composed of two single tapered bodies. Namely, the bidirectional tapered body is bidirectionally composed of two single tapered bodies in two directions, wherein the tapered body has a left taper and a right taper opposite in directions and same and/or approximately same in tapers. The bidirectional tapered body is helically distributed on an inner surface of the cylindrical body to form the internal thread of the symmetrical bidirectional tapered thread, and a complete unit thread of the internal thread is a dumbbell-like shaped special bidirectional tapered geometry small in the middle and large in both ends and having a left taper same as and/or approximately same as a right taper.

For the connection structure of the internal thread of the dumbbell-like shaped symmetrical bidirectional tapered thread and the traditional thread, the definition of the dumbbell-like shaped symmetrical bidirectional tapered internal thread may be expressed as: “a dumbbell-like shaped special helical bidirectional tapered geometry on an inner surface of a cylinder or a cone, which is small in the middle and large in both ends and has the symmetrical bidirectional tapered holes with the specified left and right tapers opposite in directions and same and/or approximately same in tapers, and the symmetrical bidirectional tapered holes are continuously and/or discontinuously distributed along the helical line”. The head or the tail of the symmetrical bidirectional tapered thread may be an incomplete bidirectional tapered geometry due to manufacturing and other reasons. Different from the modern thread technology, the thread technology has changed from the engagement relationship between the internal thread and the external thread in the modern thread to the cohesion relationship between the internal thread and the external thread in the bidirectional tapered thread.

The bidirectional tapered internal thread and traditional thread comprises an external thread and an internal thread in mutual thread fit. The internal thread is a bidirectional tapered hole helically distributed on an inner surface of a cylindrical body, while the external thread is a special tapered body helically distributed on an outer surface of a columnar body. Namely, the internal thread is presented by the helical bidirectional tapered hole and exists in a form of a “non-entity space”; and the external thread is presented by the helical special tapered body and exists in a form of a “material entity. The non-entity space refers to a space environment capable of accommodating the above material entity. The internal thread is a containing part; and the external thread is a contained part. The internal thread and the external thread are fitted together by screwing the two bidirectional tapered geometries pitch by pitch, and the internal thread is cohered with the external thread till one side bears the load bidirectionally or both the left side and the right side bear the load bidirectionally at the same time or till the external thread and the internal thread are in interference fit. Whether the two sides bear bidirectional load at the same time is related to the actual working conditions in the application field. Namely, the bidirectional tapered hole of the internal thread of the bidirectional tapered thread contains the traditional external thread pitch by pitch through the special tapered body formed by contracting with the internal thread of the bidirectional tapered thread, i.e., the internal thread is cohered with the corresponding external thread pitch by pitch.

The thread connection pair is a thread pair formed by fitting a helical outer conical surface with a helical inner conical surface to form a cone pair. An inner conical surface of an internal cone body of the bidirectional tapered thread is a bidirectional conical surface. When the thread connection pair is formed between the bidirectional tapered internal thread and a traditional external thread, a joint surface between the inner conical surface of the bidirectional tapered internal thread and the traditional external thread is used as a bearing surface, i.e., the conical surface is used as the bearing surface to realize the technical performance of connection. The self-locking, self-positioning, reusability, fatigue resistance and other capabilities of the thread pair mainly depend on size of the conical surface and taper of the conical surface of the internal thread of the bidirectional tapered thread as well as size of a special outer conical surface and taper thereof, wherein the special outer conical surface is formed by contacting the external thread of the traditional thread with the bidirectional tapered internal thread, and the thread connection pair is a non-toothed thread.

Different from that the principle of inclined plane of the existing thread which shows a unidirectional force distributed on the inclined plane as well as an engagement relationship between the internal tooth bodies and the external tooth bodies, the internal thread body of the bidirectional tapered internal thread and traditional thread, i.e., the bidirectional tapered thread is composed of two plain lines of the cone body in two directions (i.e. bidirectional state) when viewed from any cross section of the single cone body distributed on either left or right side along the cone axis. The plain line is the intersection line of the conical surfaces and a plane through which the cone axis passes. The cone principle of the connection structure of the bidirectional tapered internal thread and the traditional thread shows an axial force and a counter-axial force, both of which are combined by bidirectional forces, wherein the axial force and the corresponding counter-axial force are opposite to each other. The internal thread and the external thread are in a cohesion relationship. Namely, the thread pair is formed by cohering the external thread with the internal thread, i.e., the tapered hole (internal cone) is cohered with the corresponding cone body (external cone body) pitch by pitch till the self-positioning is realized by cohesion fit or till the self-locking is realized by interference contact. Namely, the self-locking or self-positioning of the internal cone body and the external cone body is realized by radially cohering the tapered hole and the special tapered body to realize the self-locking or self-positioning of the thread pair, rather than the thread connection pair, composed of the internal thread and the external thread in the traditional thread, which realizes a thread connection performance by mutual abutment between the tooth bodies.

A self-locking force will arise when the cohesion process between the internal thread and the external thread reaches certain conditions. The self-locking force is generated by a pressure produced between an axial force of the internal cone and a counter-axial force of the external cone. Namely, when the internal cone and the external cone form the cone pair, the inner conical surface of the internal cone body is cohered with the outer conical surface of the external cone body; and the inner conical surface is in close contact with the outer conical surface. The axial force of the internal cone and the counter-axial force of the external cone are concepts of forces unique to the bidirectional tapered thread technology, i.e., the cone pair technology, in the present invention.

The internal cone body exists in a form similar to a shaft sleeve, and generates the axial force pointing to or pressing toward the cone axis under the action of external load. The axial force is bidirectionally combined by a pair of centripetal forces which are distributed in mirror image with the cone axis as a center and are respectively perpendicular to two plain lines of the cone body; i.e., the axial force passes through the cross section of the cone axis and is composed of two centripetal forces which are bidirectionally distributed on two sides of the cone axis in mirror image with the cone axis being the center, are respectively perpendicular to the two plain lines of the cone body, and point to or press toward a common point of the cone axis; and the axial force passes through a cross section of a thread axis and is composed of two centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The axial force is densely distributed on the cone axis and/or the thread axis in an axial and circumferential manner, and corresponds to an axial force angle, wherein the axial force angle is formed by an angle between two centripetal forces forming the axial force and depends on the taper of the cone body, i.e., the taper angle.

The external cone body exists in a form similar to a shaft, has relatively strong ability to absorb various external loads, and generates a counter-axial force opposite to each axial force of the internal cone body. The counter-axial force is bidirectionally combined by a pair of counter-centripetal forces which are distributed in mirror image with the cone axis as the center and are respectively perpendicular to the two plain lines of the cone body; i.e., the counter-axial force passes through the cross section of the cone axis and is composed of two counter-centripetal forces which are bidirectionally distributed on two sides of the cone axis in mirror image with the cone axis as the center, are respectively perpendicular to the two plain lines of the cone body, and point to or press toward the common point of the cone axis; and the counter-axial force passes through the cross section of the thread axis and is composed of two counter-centripetal forces which are bidirectionally distributed on two sides of the thread axis in mirror image and/or approximate mirror image with the thread axis as the center, are respectively perpendicular to the two plain lines of the cone body, and point to or press toward the common point and/or approximate common point of the thread axis when the thread is combined by the cone body and the helical structure and is applied to the thread pair. The counter-axial force is densely distributed on the cone axis and/or the thread axis in the axial and circumferential manner, and corresponds to a counter-axial force angle, wherein the counter-axial force angle is formed by an angle between the two counter-centripetal forces forming the counter-axial force and depends on the taper of the cone body, i.e., the taper angle.

The axial force and the counter-axial force start to be generated when the internal cone and the external cone of the cone pair are in effective contact, i.e., a pair of corresponding and opposite axial force and counter-axial force always exist during the effective contact of the internal cone and the external cone of the cone pair. The axial force and the counter-axial force are bidirectional forces bidirectionally distributed in mirror image with the cone axis and/or the thread axis as the center, rather than unidirectional forces. The cone axis and the thread axis are coincident axes, i.e., the same axis and/or approximately the same axis. The counter-axial force and the axial force are reversely collinear and are reversely collinear and/or approximately reversely collinear when the cone body and the helical structure are combined into the thread and form the thread pair. The internal cone and the external cone are cohered till interference is achieved, so the axial force and the counter-axial force generate a pressure on the contact surface between the inner conical surface and the outer conical surface and are densely and uniformly distributed on the contact surface between the inner conical surface and the outer conical surface axially and circumferentially. When the cohesion movement of the internal cone and the external cone continues till the cone pair reaches the pressure generated by interference fit to combine the internal cone with the external cone, i.e., the pressure enables the internal cone body to be cohered with the external cone body to form a similar integral structure and will not cause the internal cone body and the external cone body to separate from each other under the action of gravity due to arbitrary changes in a direction of a body position of the similar integral structure after the external force caused by the pressure disappears. The cone pair generates self-locking, which means that the thread pair generates self-locking. The self-locking performance has a certain degree of resistance to other external loads which may cause the internal cone body and the external cone body to separate from each other except gravity. The cone pair also has the self-positioning performance which enables the internal cone and the external cone to be fitted with each other. However, not any axial force angle and/or counter-axial force angle may enable the cone pair to generate self-locking and self-positioning.

When the axial force angle and/or the counter-axial force angle is less than 180° and greater than 127°, the cone pair has the self-locking performance. When the axial force angle and/or the counter-axial force angle is infinitely close to 180°, the cone pair has the best self-locking performance and the weakest axial bearing capacity. When the axial force angle and/or the counter-axial force angle is equal to and/or less than 127° and greater than 0°, the cone pair is in a range of weak self-locking performance and/or no self-locking performance. When the axial force angle and/or the counter-axial force angle tends to change in a direction infinitely close to 0°, the self-locking performance of the cone pair changes in a direction of attenuation till the cone pair completely has no self-locking ability; and the axial bearing capacity changes in a direction of enhancement till the axial bearing capacity is the strongest.

When the axial force angle and/or the counter-axial force angle is less than 180° and greater than 127°, the cone pair is in a strong self-positioning state, and the strong self-positioning of the internal cone body and the external cone body is easily achieved. When the axial force angle and/or the counter-axial force angle is infinitely close to 180°, the internal cone body and the external cone body of the cone pair have the strongest self-positioning ability. When the axial force angle and/or the counter-axial force angle is equal to and/or less than 127° and greater than 0°, the cone pair is in a weak self-positioning state. When the axial force angle and/or the counter-axial force angle tends to change in the direction infinitely close to 0°, the mutual self-positioning ability of the internal and external cone bodies of the cone pair changes in the direction of attenuation till the cone pair is close to have has no self-positioning ability at all.

Comparing the bidirectional tapered thread connection pair with the containing and contained relationship of irreversible one-sided bidirectional containment that the unidirectional tapered thread of single tapered body invented by the applicant before which can only bear the load by one side of the conical surface, the reversible left and right-sided bidirectional containment of the bidirectional tapered threads of double tapered bodies enables the left side and/or the right side of the conical surface to bear the load, and/or the left conical surface and the right conical surface to respectively bear the load, and/or the left conical surface and the right conical surface to simultaneously bear the load bidirectionally, and further limits a disordered degree of freedom between the tapered hole and the special external cone body; and a helical movement enables the connection structure of the bidirectional tapered internal thread and the traditional thread to obtain a necessary ordered degree of freedom, thereby effectively combining the technical characteristics of the cone pair and the thread pair to form a brand-new thread technology.

When the connection structure of the bidirectional tapered internal thread and the traditional thread is used, the special conical surface of the traditional external thread is in mutual fit with the conical surface of the bidirectional tapered hole of the internal thread of the bidirectional tapered thread.

The self-locking and/or self-positioning of the thread connection pair is not realized at any taper or any taper angle of the bidirectional tapered body, i.e., the tapered hole of the bidirectional tapered internal thread of the cone pair in the connection structure of the bidirectional tapered internal thread and the traditional thread. The connection structure of the bidirectional tapered internal thread and the traditional thread has the self-locking and self-positioning performances only if the internal cone body reaches a certain taper or a certain taper angle. The taper comprises the left taper and the right taper of the internal thread body. The taper angle comprises a left taper angle and a right taper angle of the internal thread body. The left taper corresponds to the left taper angle, i.e., a first taper angle α1. It is preferable that the first taper angle α1 is greater than 0° and smaller than 53°; and preferably, the first taper angle α1 is 2°-40°. The right taper corresponds to the right taper angle, i.e., a second taper angle α2. It is preferable that the second taper angle α2 is greater than 0° and smaller than 53°; and preferably, the second taper angle α2 is 2°-40°. In individual special fields, it is preferable that the first taper angle α1 is greater than or equal to 53° and smaller than 180°, and the second taper angle α2 is greater than or equal to 53° and smaller than 180°. It is preferable that the first taper angle α1 is greater than or equal to 53° and smaller than or equal to 90°; and the second taper angle α2 is greater than or equal to 53° and smaller than or equal to 90°.

The above-mentioned individual special fields refer to the application fields of thread connection such as transmission connection with low requirements on self-locking performance or even without self-locking performance and/or with low requirements on self-positioning performance and/or with high requirements on axial bearing capacity and/or with indispensable anti-locking measures.

According to the bidirectional tapered internal thread and traditional thread, the internal thread is arranged on the inner surface of the cylindrical body, wherein a nut body is arranged on the cylindrical body, the tapered hole is helically distributed on an inner surface of the nut body, comprising a symmetrical bidirectional tapered hole. The cylindrical body comprises cylindrical and/or non-cylindrical workpieces and objects that need to be machined with internal threads on inner surfaces thereof, wherein the inner surfaces comprise geometric shapes of inner surfaces such as cylindrical surfaces, non-cylindrical surfaces such as conical surfaces, and the like.

According to the bidirectional tapered internal thread and traditional thread, the symmetrical bidirectional tapered hole, i.e., the internal thread is formed by oppositely jointing symmetrical upper sides of two identical tapered holes, and lower sides of the two identical tapered holes are located at two ends of the bidirectional tapered hole and are mutually jointed with the lower sides of the adjacent bidirectional tapered hole and/or to be mutually jointed with the lower sides of the adjacent bidirectional tapered hole. The internal thread comprises a first helical conical surface of the tapered hole, a second helical conical surface of the tapered hole and an internal helical line. In a cross section through which the thread axis passes, the complete single-pitch symmetrical bidirectional tapered internal thread is a dumbbell-like shaped special bidirectional tapered geometry small in the middle and large in both ends and having a left taper same as and/or approximately same as a right taper. The bidirectional tapered hole comprises a conical surface of the bidirectional tapered hole. An angle formed between two plain lines of a left conical surface of the bidirectional tapered hole, i.e., a first helical conical surface of the tapered hole, is the first taper angle α1. The left taper is formed on the first helical conical surface of the tapered hole and is subjected to a right-direction distribution. An angle formed between two plain lines of a right conical surface of the bidirectional tapered hole, i.e., a second helical conical surface of the tapered hole, is the second taper angle α2. The right taper is formed on the second helical conical surface of the tapered hole and is subjected to a left-direction distribution. The taper directions corresponding to the first taper angle α1 and the second taper angle α2 are opposite. The plain line is an intersection line of the conical surface and the plane through which the cone axis passes. A shape formed by the first helical conical surface of the tapered hole and the second helical conical surface of the tapered hole of the bidirectional tapered hole is the same as a shape of a helical outer flank of a rotating body, wherein the rotating body is formed by two hypotenuses of a right-angled trapezoid union being rotated around a right-angled side of the right-angled trapezoid union, and, at the same time, the right-angled trapezoid union axially moves at a constant speed along a central axis of the cylindrical body; wherein the right-angled trapezoid union refers to a special geometry formed by oppositely jointing symmetrical upper sides of two identical right-angled trapezoids, and lower sides of the two identical right-angled trapezoids are respectively located at two ends of the right-angled trapezoid union; and the two right-trapezoids are coincident with the central axis of the cylindrical body.

Due to the unique technical characteristic and advantage that the thread body of the bidirectional tapered internal thread is a tapered body, i.e., the tapered hole, the bidirectional tapered internal thread has a stronger ability to assimilate heterogeneous threads, i.e., has the ability to assimilate the traditional thread fitted therewith into the special form of tapered thread having the same technical characteristics and properties as the bidirectional tapered internal thread. The traditional thread after being assimilated by the tapered thread, i.e., the alienated traditional thread, seems to have little difference in tooth body shape from that of the traditional thread, but does not possess substantial technical contents of the thread body of the traditional thread, and the thread body thereof has changed from a tooth body property of the original traditional thread into a special tapered geometry with a thread body property of the tapered thread (i.e., the tapered body property) and technical characteristics. The special conical geometry has a special conical surface that can be fitted with the helical conical surface of the tapered thread in a radial direction. The above-mentioned traditional threads comprise a triangular thread, a trapezoidal thread, a sawtooth thread, a rectangular thread, an arc threads and threads of other geometric shapes which can be screwed with the above-mentioned bidirectional tapered thread to form a thread connection pair, but are not limited to the above threads.

When the traditional external thread and the bidirectional tapered internal thread are fitted to form the thread connection pair, the traditional external thread at this time is not the traditional thread in the original sense, but a special form of tapered thread assimilated by the tapered thread, and a part of the traditional external thread contacted with the bidirectional tapered internal thread forms an outer surface of a special tapered body of the traditional external thread of the thread connection pair, which can be matched with the helical conical surface of the tapered thread. With the increase of screwing times, an effective conical surface area of the special conical surface on the special tapered body of the traditional external thread will increase continuously, i.e., the special conical surface will increase continuously and tend to change towards a direction having a larger contact surface with the conical surface of the tapered hole of the bidirectional tapered internal thread, which essentially forms a special tapered body already having the technical spirit of the present invention although the tapered geometry shape is incomplete. Further, the special tapered body is a thread body formed by the traditional external thread assimilated by the bidirectional tapered internal thread due to cohesive contact with the bidirectional tapered internal thread, and is a special tapered geometry transformed from a tooth body of the traditional external thread. The special tapered body has an outer surface, i.e., a special conical surface, which can be matched with the conical surface of the bidirectional tapered hole in the radial direction. Namely, the thread connection pair is a thread pair formed by mutually fitting the special conical surface of the special tapered body formed by the helical special conical surface (i.e., the traditional external thread) due to contact with the bidirectional tapered internal thread, with the helical inner conical surface, i.e., the inner conical surface of the bidirectional tapered internal thread to form a cone pair. The inner conical surface, i.e., the inner conical surface of the internal cone body, i.e., the helical conical surface of the tapered hole of the bidirectional tapered internal thread is a bidirectional conical surface, and the traditional thread assimilated by the inner conical surface is an alienated traditional thread, which is a special form of tapered thread. The outer conical surface of the special form of tapered thread, i.e., the special conical surface of the traditional external thread first appears in the form of a line, and gradually increases in the outer conical surface as the contact times between a tooth cusp of the traditional external thread and the tapered hole of the bidirectional tapered internal thread increase. Namely, the special conical surface of the traditional external thread is constantly changed and enlarged from a microscopic surface (which is a line in a macroscopic aspect) to a macroscopic surface, and the outer conical surface matched with the bidirectional tapered internal thread can also be directly machined at the tooth cusp of the traditional external thread, all of which conform to the technical spirit of the present invention.

According to the bidirectional tapered internal thread and traditional thread, the external thread is arranged on the outer surface of the columnar body, wherein a screw body is arranged on the columnar body, the special tapered body is helically distributed on an outer surface of the screw body. The special tapered body refers to a special tapered body formed by the traditional external thread due to cohesive contact with the bidirectional tapered internal thread. A special conical surface is arranged on the special tapered body. The columnar body may be solid or hollow, comprising cylindrical and/or non-cylindrical workpieces and objects that need to be machined with threads on outer surfaces thereof, wherein the outer surfaces comprise geometric shapes of outer surfaces such as cylindrical surfaces, non-cylindrical surfaces such as conical surfaces, and the like.

When the connection structure of the bidirectional tapered internal thread and the traditional thread is working, relationships between the connection structure and the workpiece comprises rigid connection and non-rigid connection. The rigid connection means that a nut bearing surface and a workpiece bearing surface are mutually bearing surfaces, comprising structural forms like single nut and double nuts, etc. The non-rigid connection means that opposite side end surfaces of two nuts are mutually bearing surfaces and/or the opposite side end surfaces of the two nuts are mutually bearing surfaces indirectly if a gasket is provided therebetween. The non-rigid connection is mainly applied to non-rigid materials or non-rigid connection workpieces such as transmission pieces and other application fields that need to be installed through double nuts to satisfy requirements, etc. The workpieces refer to connected objects comprising the workpieces, and the gasket refers to a gasket-comprising spacer.

According to the bidirectional tapered internal thread and traditional thread, when a connection structure of a bolt of the traditional thread and double nuts of the bidirectional tapered thread is adopted and a relationship with a fastened workpiece is rigid connection, working bearing surfaces of the thread are different. When the cylindrical body is located at a left side of the fastened workpiece, i.e., a left end surface of the fastened workpiece, and a right end surface of the cylindrical body (i.e., the left nut body) serves as the locking bearing surface between the left nut body and the fastened workpiece, the left helical conical surface of the bidirectional tapered thread of the left nut body, i.e., the first helical conical surface of the tapered hole and the special conical surface of the traditional external thread are the tapered thread bearing surface, and the first helical conical surface of the tapered hole and the special conical surface of the traditional external thread are mutually bearing surfaces. When the cylindrical body is located at a right side of the fastened workpiece, i.e., a right end surface of the fastened workpiece, and a left end surface of the cylindrical body (i.e., the right nut body) serves as the locking bearing surface between the right nut body and the fastened workpiece, the right helical conical surface of the bidirectional tapered thread of the right nut body, i.e., the second helical conical surface of the tapered hole and the special conical surface of the traditional external thread are the tapered thread bearing surface, and the second helical conical surface of the tapered hole and the special conical surface of the traditional external thread are mutually bearing surfaces.

According to the bidirectional tapered internal thread and traditional thread, when a connection structure of a bolt of the traditional thread and a single nut of the bidirectional tapered thread is adopted and a relationship with a fastened workpiece is rigid connection, and when a hexagon head of the bolt is located at a left side, the cylindrical body (i.e., the nut body), i.e., the single nut is located at a right side of the fastened workpiece. When the connection structure of the bolt and the single nut is working, a right end surface of the workpiece and a left end surface of the nut body serve as locking bearing surfaces between the nut body and the fastened workpiece, the right helical conical surface of the bidirectional tapered thread of the nut body, i.e., the second helical conical surface of the tapered hole and the special conical surface of the traditional external thread are the tapered thread bearing surface, and the second helical conical surface of the tapered hole and the special conical surface of the traditional external thread are mutually bearing surfaces. When the hexagon head of the bolt is located at a right side, the cylindrical body (i.e., the nut body), i.e., the single nut is located at a left side of the fastened workpiece. When the connection structure of the bolt and the single nut is working, a left end surface of the workpiece and a right end surface of the nut body serve as locking bearing surfaces between the nut body and the fastened workpiece, the left helical conical surface of the bidirectional tapered thread of the nut body, i.e., the first helical conical surface of the tapered hole and the special conical surface of the traditional external thread are the tapered thread bearing surface, and the first helical conical surface of the tapered hole and the special conical surface of the traditional external thread are mutually bearing surfaces.

According to the bidirectional tapered internal thread and traditional thread, when a connection structure of a bolt of the traditional thread and double nuts of the bidirectional tapered thread is adopted and a relationship with a fastened workpiece is non-rigid connection, working bearing surfaces of the thread are different. The cylindrical body comprises a left nut body and a right nut body. A right end surface of the left nut body and a left end surface of the right nut body are oppositely and directly contacted, and serve as mutually locking bearing surfaces. When the right end surface of the left nut body serves as the locking bearing surface, the left helical conical surface of the bidirectional tapered thread of the left nut body, i.e., the first helical conical surface of the tapered hole and the special conical surface of the traditional external thread are the tapered thread bearing surface, and the first helical conical surface of the tapered hole and the special conical surface of the traditional external thread are mutually bearing surfaces. When the left end surface of the right nut body serves as the locking bearing surface, the right helical conical surface of the bidirectional tapered thread of the right nut body, i.e., the second helical conical surface of the tapered hole and the special conical surface of the traditional external thread are the tapered thread bearing surface, and the second helical conical surface of the tapered hole and the special conical surface of the traditional external thread are mutually bearing surfaces.

According to the bidirectional tapered internal thread and traditional thread, when a connection structure of a bolt of the traditional thread and double nuts of the bidirectional tapered thread is adopted and a relationship with a fastened workpiece is non-rigid connection, working bearing surfaces of the thread are different. The cylindrical nut body comprises two cylindrical bodies, i.e., a left nut body and a right nut body. Namely, a spacer like a gasket is arranged between the left nut body and the right nut body. A right end surface of the left nut body and a left end surface of the right nut body are oppositely and indirectly contacted via the gasket, and thus serve as mutually locking bearing surfaces indirectly. When the cylindrical body is located at a left side of the gasket, i.e., a left surface of the gasket, and the right end surface of the left nut body serves as the locking bearing surface of the left nut body, the left helical conical surface of the bidirectional tapered thread of the left nut body, i.e., the first helical conical surface of the tapered hole and the special conical surface of the traditional external thread are the tapered thread bearing surface. The first helical conical surface of the tapered hole and the special conical surface of the traditional external thread are mutually bearing surfaces. When the cylindrical body is located at a right side of the gasket, i.e., a right surface of the gasket, and the left end surface of the right nut body serves as the locking bearing surface of the right nut body, the right helical conical surface of the bidirectional tapered thread of the right nut body, i.e., the second helical conical surface of the tapered hole and the special conical surface of the traditional external thread are the tapered thread bearing surface. The second helical conical surface of the tapered hole and the special conical surface of the traditional external thread are mutually bearing surfaces.

According to the bidirectional tapered internal thread and traditional thread, when a connection structure of a bolt of the traditional thread and double nuts of the bidirectional tapered thread is adopted and a relationship with a fastened workpiece is non-rigid connection, when the cylindrical body located inside, i.e., the nut body adjacent with the fastened workpiece is already effectively combined together with the columnar body (i.e., the screw body), i.e., the bolt, namely, the internal thread and the external thread forming the thread connection pair are effectively cohered together, the cylindrical body located outside, i.e., the nut body not adjacent with the fastened workpiece may keep an original situation and/or be dismounted with one nut (for example, such application fields having lightweight requirements on equipment or not needing double nuts to ensure the reliability of the connection technology) according to application conditions. The dismounted nut is not used as a connection nut, but only used as an installation process nut. An internal thread of the installation process nut is not only manufactured by adopting bidirectional tapered threads, and may also be a nut body made of unidirectional tapered threads and other threads that can be screwed with the tapered threads, i.e., threads comprising triangular threads, trapezoidal threads, sawtooth threads and other traditional threads, but are not limited to the above threads. Any applicable threads can be adopted. On the premise of ensuring the reliability of the connection technology, the thread connection pair is a closed-loop fastening technical system, namely, after the internal thread and the external thread of the thread connection pair are effectively cohered together, the thread connection pair will become an independent technical system without relying on technical compensations from a third party to ensure the technical effectiveness of the connection technical system. In other words, the effectiveness of the thread connection pair will not be affected even without the support of other objects and even if there is a gap between the thread connection pair and the fastened workpiece. This will greatly reduce the weight of the equipment, remove invalid loads, and improve the technical requirements on an effective loading capability, braking performance, and energy conservation and emission reduction of the equipment, which is a unique thread technical advantage no matter the relationship between the thread connection pair of the connection structure of the bidirectional tapered internal thread and the traditional thread and the fastened workpiece is non-rigid connection or rigid connection, and is not possessed by other thread technologies.

During transmission connection of the bidirectional tapered internal thread and traditional thread, bidirectional bearing is implemented through screwing connection of the bidirectional tapered hole and the special tapered body of the traditional external thread. When the external thread and the internal thread form the thread pair, a clearance between the bidirectional tapered hole of the tapered internal thread and the special tapered body of the traditional external thread is required. If oil and other media are lubricated between the internal thread and the external thread, a bearing oil film will be easily formed, and the clearance is beneficial to the formation of the bearing oil film. The application of the bidirectional tapered internal thread and traditional thread in transmission connection is equivalent to a pair of sliding bearings consisting of one pair and/or several pairs of sliding bearings, namely, each pitch of the bidirectional tapered internal thread bidirectionally contains a corresponding pitch of traditional external thread to form a pair of sliding bearings. A number of the formed sliding bearings is adjusted according to the application conditions, namely, a pitch number of containing and contained threads cohered by the effectively bidirectional jointing, i.e., effectively bidirectional contact of the bidirectional tapered internal thread and the traditional external thread is designed according to application conditions. Through the containment of the special tapered body of the traditional external thread by the tapered hole of the tapered internal thread, by virtue of positioning in multiple directions such as radial, axial, angular and circumferential, and preferably through the containment of the special tapered body by the bidirectional tapered hole and the main positioning in the radial and circumferential directions supplemented by the auxiliary positioning in the axial and angular directions, so as to form multidirectional positioning of the internal and external cone bodies, till the conical surface of the bidirectional tapered hole is cohered with the special conical surface of the special tapered body to implement self-positioning or till self-locking is generated by interference fit, a special combining technology of the cone pair and the thread pair is constituted, which ensures the precision, efficiency and reliability of the transmission connection of the tapered thread technology and especially the bidirectional tapered internal thread and traditional thread.

When the bidirectional tapered internal thread and traditional thread is tightly connected and hermetically connected, technical performances thereof are realized through the screwing connection of the bidirectional tapered hole of the tapered internal thread and the special tapered body of the traditional external thread, namely, the technical performances are realized through sizing of the first helical conical surface of the tapered hole and the special conical surface of the special tapered body of the traditional external thread till interference and/or sizing of the second helical conical surface of the tapered hole and the special conical surface of the special tapered body of the traditional external thread till interference. According to application conditions, one direction bears the load and/or two directions simultaneously bear the load respectively. Namely, under the guidance of the helical line, an outer diameter of an internal cone of the bidirectional tapered hole and an inner diameter of a special external cone of the traditional external thread are centered till the first helical conical surface of the tapered hole and the special conical surface of the special tapered body of the traditional external thread are cohered till interference contact and/or the second helical conical surface of the tapered hole and the special conical surface of the special tapered body of the traditional external thread are cohered till interference contact. In other words, through the containment of the special tapered body of the traditional external thread by the bidirectional internal cone body of the tapered internal thread, by virtue of positioning in multiple directions such as radial, axial, angular and circumferential, and preferably through the containment of the special tapered body by the bidirectional tapered hole and the main positioning in the radial and circumferential directions supplemented by the auxiliary positioning in the axial and angular directions, so as to form multidirectional positioning of the internal and external cone bodies, till the conical surface of the bidirectional tapered hole is cohered with the special conical surface of the special tapered body to implement self-positioning or till self-locking is generated by interference fit, a special combining technology of the cone pair and the thread pair is constituted, which ensures the efficiency and reliability of the connection structure of the bidirectional tapered internal thread and the traditional thread, thus realizing technical performances such as connection, locking, anti-loosening, bearing, fatigue and sealing of mechanical structures.

Therefore, the technical performances such as the transmission precision and efficiency, the load bearing capacity, the locking force of self-locking, the anti-loosening ability and the sealing performance of the bidirectional tapered internal thread and traditional thread are related to the sizes of the first helical conical surface of the tapered hole and the formed left taper, i.e., the first taper angle α1, the second helical conical surface of the tapered hole and the formed right taper, i.e., the second taper angle α2, and are also related to the sizes of the special outer conical surface of the traditional external thread formed by the traditional external thread due to contact with the internal thread of the bidirectional tapered thread and the taper of the special outer conical surface. Material friction coefficient, processing quality and application conditions of the columnar body and the cylindrical body also have a certain impact on the cone fit.

In the bidirectional tapered internal thread and traditional thread, when the right-angled trapezoid union rotates a circle at a constant speed, an axial movement distance of the right-angled trapezoid union is at least double a length of the sum of the right-angled sides of the two identical right-angled trapezoids. This structure ensures that the first helical conical surface of the tapered hole and the second helical conical surface of the tapered hole have sufficient length, thus ensuring sufficient effective contact area and intensity when the conical surface of the bidirectional tapered hole is fitted with the special conical surface of the traditional external thread as well as ensuring efficiency required by the helical movement.

In the bidirectional tapered internal thread and traditional thread, when the right-angled trapezoid union rotates a circle at a constant speed, an axial movement distance of the right-angled trapezoid union is equal to a length of the sum of the right-angled sides of the two identical right-angled trapezoids. This structure ensures that the first helical conical surface of the tapered hole and the second helical conical surface of the tapered hole have sufficient length, thus ensuring sufficient effective contact area and intensity when the conical surface of the bidirectional tapered hole is fitted with the special conical surface of the traditional external thread as well as ensuring efficiency required by the helical movement.

In the bidirectional tapered internal thread and traditional thread, the first helical conical surface of the tapered hole and the second helical conical surface of the tapered hole are continuous helical surfaces or discontinuous helical surfaces.

In the bidirectional tapered internal thread and traditional thread, the special conical surface of the special tapered body is a continuous helical surface or discontinuous helical surface.

In the bidirectional tapered internal thread and traditional thread, one end and/or two ends of the columnar body may be used as a screw-in end screwed into a connecting hole of the cylindrical body, and the thread connection function can be realized through the contact and/or interference fit between the first helical conical surface of the tapered internal thread and the special conical surface of the traditional external thread and/or the contact and/or interference fit between the second helical conical surface of the tapered internal thread and the special conical surface of the traditional external thread.

In the bidirectional tapered internal thread and traditional thread, a head with a size greater than an outer diameter of the columnar body is arranged at one end of the columnar body, and/or a head with a size smaller than a minor diameter of the bidirectional tapered external thread of the screw body of the columnar body is arranged at one end and/or two ends of the columnar body, and the connecting hole is a threaded hole arranged on the nut. Namely, the columnar body connected with the head is a bolt; and the columnar body having no head and/or having heads at both ends smaller than the minor diameter of the bidirectional tapered external thread and/or having no thread at the middle and having the bidirectional tapered external threads at both ends is a stud, and the connecting hole is arranged in the nut.

Compared with the prior art, the connection structure of the bidirectional tapered internal thread and the traditional thread has the advantages of reasonable design, simple structure, convenient operation, large locking force, high bearing capacity, excellent anti-loosening performance, high transmission efficiency and precision, good mechanical sealing effect and good stability, realizes the fastening and connecting functions through bidirectional bearing or sizing of cone pair formed by coaxial inner and outer diameter sizing of the internal cone and the external cone till interference fit, can prevent loosening phenomenon during connection, and has self-locking and self-positioning functions.

### BRIEF DESCRIPTION OF THE DRAWINGS

FIG. 1 is a structural schematic diagram of a connection pair of an internal thread of a dumbbell-like shaped symmetrical bidirectional tapered thread and a traditional thread in Embodiment 1 provided by the present invention.

FIG. 2 is a structural schematic diagram of the internal thread of the dumbbell-like shaped symmetrical bidirectional tapered thread and a complete unit thread thereof in Embodiment 1 provided by the present invention.

FIG. 3 is a structural schematic diagram of a connection pair of double nuts of a dumbbell-like shaped symmetrical bidirectional tapered thread and a traditional thread in Embodiment 2 provided by the present invention.

FIG. 4 is a structural schematic diagram of a connection pair of a single nut of a dumbbell-like shaped symmetrical bidirectional tapered thread and a traditional thread in Embodiment 3 provided by the present invention.

FIG. 5 is a structural schematic diagram of a connection pair of double nuts of a dumbbell-like shaped symmetrical bidirectional tapered thread and a traditional thread in Embodiment 4 provided by the present invention.

FIG. 6 is a structural schematic diagram of a connection pair of double nuts (provided with a gasket therebetween) of a dumbbell-like shaped symmetrical bidirectional tapered thread and a traditional thread in Embodiment 5 provided by the present invention.

FIG. 7 is a graphic presentation of that “the thread of the existing thread technology is an inclined plane on a cylindrical or conical surface” involved in the background of the present invention.

FIG. 8 is a graphic presentation of that “an inclined plane slider model of the principle of the existing thread technology-the principle of inclined plane” involved in the background of the present invention.

FIG. 9 is a graphic presentation of “a thread rise angle of the existing thread technology” involved in the background of the present invention

In the figures, tapered thread 1, cylindrical body 2, nut body 21, nut body 22, columnar body 3, screw body 31, tapered hole 4, bidirectional tapered hole 41, conical surface 42 of the tapered hole, first helical conical surface 421 of the tapered hole, first taper angle α1, second helical conical surface 422 of the tapered hole, second taper angle α2, internal helical line 5, internal thread 6, special tapered body 7, special conical surface 72, external thread 9, dumbbell-like shape 94, left taper 95, right taper 96, left-direction distribution 97, right-direction distribution 98, thread connection pair and/or thread pair 10, clearance 101, locking bearing surface 111, locking bearing surface 112, tapered thread bearing surface 122, tapered thread bearing surface 121, workpiece 130, nut body locking direction 131, gasket 132, cone axis 01, thread axis 02, slider A on the inclined surface, inclined surface B, gravity G, gravity component G1 along the inclined plane, friction force F, thread rise angle φ, equivalent friction angle P, major diameter d of the traditional external thread, minor diameter d1 of the traditional external thread and pitch diameter d2 of the traditional external thread.

### DETAILED DESCRIPTION OF PREFERRED EMBODIMENTS

The present invention will be further described in detail below with reference to the accompany drawings and specific embodiments.

### Embodiment 1

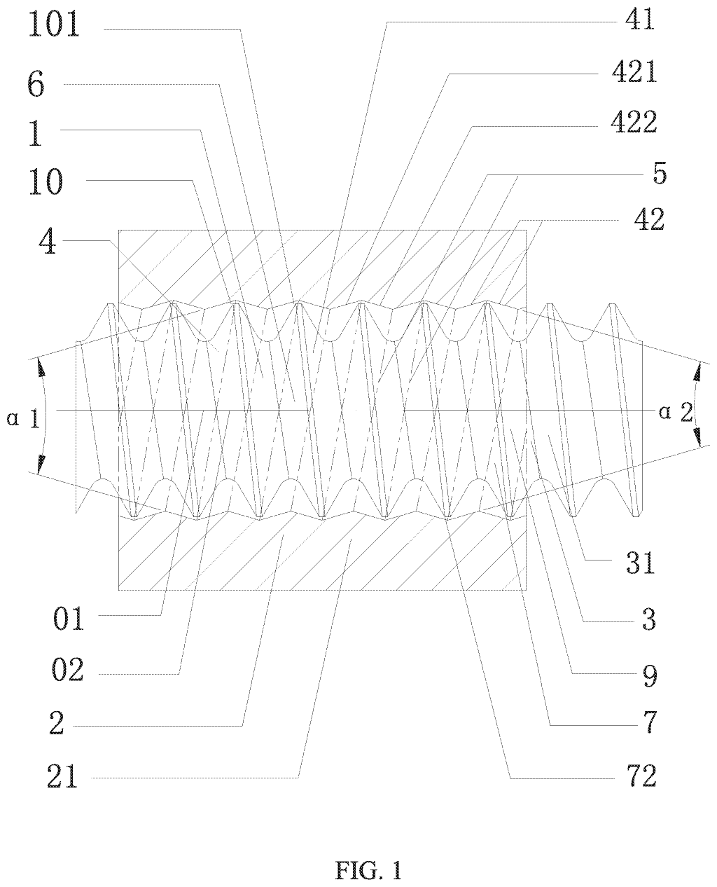

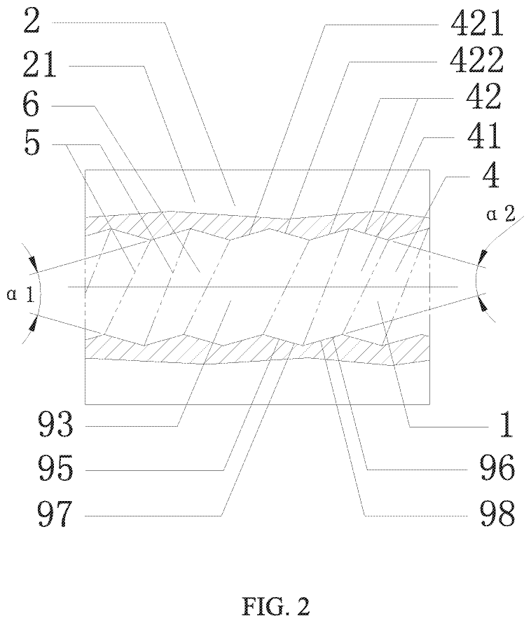

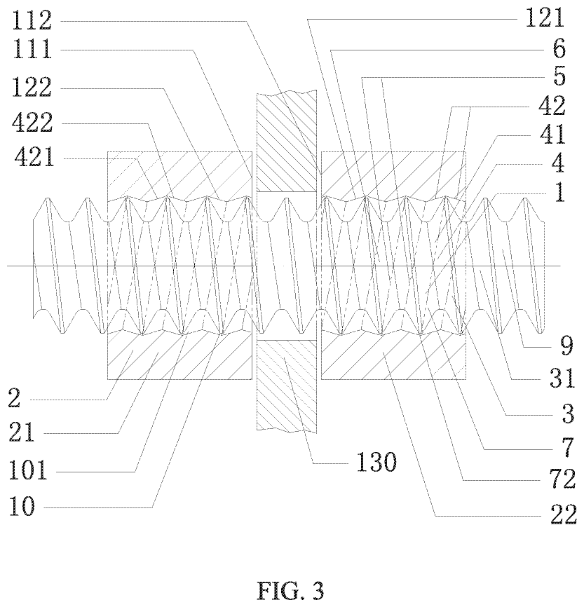

As shown in FIGS. 1 and 2, a connection structure of a traditional external thread 9 and a symmetrical bidirectional tapered internal thread 6 is adopted in the embodiment, wherein a connection pair 10 of the bidirectional tapered internal thread and the traditional thread comprises a bidirectional tapered hole 41 helically distributed on an inner surface of a cylindrical body 2 and a special tapered body 7 helically distributed on an outer surface of a columnar body 3 and formed by the external thread 9 of the traditional thread due to contact with the internal thread 6 of the bidirectional tapered thread, namely, comprises the external thread 9 and the internal thread 6 in mutual thread fit. The internal thread 6 is presented by the helical bidirectional tapered hole 41 and exists in a form of a “non-entity space”; and the external thread 9 is presented by the helical special tapered body 7 and exists in a form of a “material entity”. The internal thread 6 and the external thread 9 are subjected to a relationship of containing part and contained part as follows: the internal thread 6 and the external thread 9 are sleeved together by screwing pitch by pitch and cohered till interference fit is achieved, i.e., the bidirectional tapered hole 41 contains the special tapered body 7 formed by the traditional external thread 9 due to contact with the bidirectional tapered internal thread 6 pitch by pitch. Namely, the internal thread 6 contains the external thread 9 pitch by pitch. The bidirectional containment limits a disordered degree of freedom between the tapered hole 4 and the special tapered body 7 of the traditional external thread 9; and the helical movement enables the thread connection pair 10 of the bidirectional tapered internal thread and the traditional thread to obtain a necessary ordered degree of freedom, thus effectively combining technical characteristics of a cone pair and a thread pair.

When the connection pair 10 of the bidirectional tapered internal thread and the traditional thread in the embodiment is in use, a conical surface 42 of the tapered hole and a special conical surface 72 of the special tapered body 7 of the traditional external thread 9 are in mutual fit.

According to the connection pair 10 of the bidirectional tapered internal thread and the traditional thread, the thread connection pair 10 has the self-locking and self-positioning performances only if the tapered hole 4 reaches a certain taper, i.e., the cone body reaches a certain taper angle. The taper comprises a left taper 95 and a right taper 96. The taper angle comprises a left taper angle and a right taper angle. The left taper 95 corresponds to the left taper angle, i.e., a first taper angle α1. It is preferable that the first taper angle α1 is greater than 0° and smaller than 53°; and preferably, the first taper angle α1 is 2°-40°. The right taper 96 corresponds to the right taper angle, i.e., a second taper angle α2. It is preferable that the second taper angle α2 is greater than 0° and smaller than 53°; and preferably, the second taper angle α2 is 2°-40°. In individual special fields, transmission connection application fields without self-locking and/or with low requirements on self-positioning performances and/or with indispensable anti-locking measures, it is preferable that the first taper angle α1 is greater than or equal to 53° and smaller than 180°, and the second taper angle α2 is greater than or equal to 53° and smaller than 180°.

When the external thread 9 is arranged on the outer surface of the columnar body 3, the columnar body 3 is provided with a screw body 31. The traditional external thread 9 is arranged on an outer surface of the screw body 31. The traditional external thread 9 refers to threads of other geometric shapes comprising triangular threads, trapezoidal threads and sawtooth threads that can be screwed with the above bidirectional tapered thread 1 to form the thread connection pair 10. When the traditional external thread 9 and the bidirectional tapered internal thread 6 are fitted to form the thread connection pair 10, the traditional external thread 9 at this time is not the traditional thread in the original sense, but a special form of tapered thread 1. A part of the traditional external thread 9 contacted with the bidirectional tapered internal thread 6 forms the special tapered body 7 of the traditional external thread 9 of the thread connection pair 10. A special conical surface 72 is provided on the special tapered body. With the increase of screwing times, an effective conical surface area of the special conical surface 72 on the special tapered body 7 of the traditional external thread 9 will increase continuously, i.e., the special conical surface 72 will increase continuously and tend to change towards a direction having a larger contact surface with the conical surface of the bidirectional tapered internal thread 6, which essentially forms a special tapered body 7 already having the technical spirit of the present invention although the tapered geometrical shape is incomplete. The outer conical surface, i.e., the special conical surface 72 of the traditional external thread 9 first appears in a form of a line, and gradually increases as the contact times between a tooth cusp of the traditional external thread 9 and the tapered hole 4 of the internal thread 6 of the bidirectional tapered thread increase. Namely, the special conical surface 72 of the traditional external thread 9 is constantly changed and enlarged from line to surface, and the outer conical surface matched with the bidirectional tapered internal thread 6 may also be directly machined at the tooth cusp of the traditional external thread 9, all of which conform to the technical spirit of the present invention. The columnar body 3 may either be solid or hollow, comprising cylindrical, conical and tubular workpieces and objects that need to be machined with the external threads on outer surfaces thereof.

The bidirectional tapered internal thread 6 is arranged on the inner surface of the cylindrical body 2, wherein the cylindrical body 2 comprises a nut body 21, the tapered hole 4 is helically distributed on an inner surface of the nut body 21, and the tapered hole 4 comprises a symmetrical bidirectional tapered hole 41. The cylindrical body 2 comprises cylindrical and/or non-cylindrical workpieces and objects that need to be machined with internal threads on inner surfaces thereof.

The dumbbell-like shaped 94 symmetrical bidirectional tapered hole 41 is formed by oppositely jointing symmetrical upper sides of two identical tapered holes, wherein lower sides of the two tapered holes are located at two ends of the bidirectional tapered hole 41 and are respectively jointed with lower sides of the adjacent bidirectional tapered hole 41 and/or to be respectively jointed with the lower sides of the adjacent bidirectional tapered hole 41. The tapered hole 4 comprises a conical surface 42 of the symmetrical bidirectional tapered hole. The internal thread 6 comprises a first helical conical surface 421 of the tapered hole, a second helical conical surface 422 of the tapered hole, and an internal helical line 5. In a cross section through which a thread axis 02 passes, the complete single-pitch symmetrical bidirectional tapered internal thread is a dumbbell-like shaped 94 special bidirectional tapered geometry small in the middle and large in both ends and having a left taper same as and/or approximately same as a right taper. The bidirectional tapered hole 41 comprises the conical surface 42 of the tapered hole. An angle formed between two plain lines of a left conical surface of the bidirectional tapered hole, i.e., a first helical conical surface 421 of the tapered hole, is the first taper angle α1. The left taper 95 is formed on the first helical conical surface 421 of the tapered hole and is subjected to a right-direction distribution 98. An angle formed between two plain lines of a right conical surface of the bidirectional tapered hole, i.e., a second helical conical surface 422 of the tapered hole, is the second taper angle α2. The right taper 96 is formed on the second helical conical surface 422 of the tapered hole and is subjected to a left-direction distribution 97. The taper directions corresponding to the first taper angle α1 and the second taper angle α2 are opposite. The plain line is an intersection line of the conical surface and a plane through which a cone axis 01 passes. A shape formed by the first helical conical surface 421 of the tapered hole and the second helical conical surface 422 of the tapered hole of the bidirectional tapered hole 41 is the same as a shape of a helical outer flank of a rotating body, wherein the rotating body is formed by two hypotenuses of a right-angled trapezoid union being rotated around a right-angled side of the right-angled trapezoid union, and, at the same time, the right-angled trapezoid union axially moves at a constant speed along a central axis of the cylindrical body 2; wherein the right-angled trapezoid union refers to a special geometry formed by oppositely jointing symmetrical upper sides of two identical right-angled trapezoids, and lower sides of the two identical right-angled trapezoids are respectively located at two ends of the right-angled trapezoid union; and the two right-trapezoids are coincident with the central axis of the cylindrical body 2.

During transmission connection of the bidirectional tapered internal thread and traditional thread, bidirectional bearing is realized through screwing connection of the bidirectional tapered hole 41 and the special tapered body 7 of the traditional external thread 9. When the external thread 9 and the internal thread 6 form the thread pair 10, a clearance 101 between the bidirectional tapered hole 41 and the special tapered body 7 of the traditional external thread 9 is required. If oil and other media are lubricated between the internal thread 6 and the external thread 9, a bearing oil film will be easily formed, and the clearance 101 is beneficial to the formation of the bearing oil film. The thread connection pair 10 is equivalent to a pair of sliding bearings consisting of one pair and/or several pairs of sliding bearings, namely, each pitch of the bidirectional tapered internal thread 6 bidirectionally contains a corresponding pitch of traditional external thread 9 to form a pair of sliding bearings. A number of the formed sliding bearings is adjusted according to the application conditions, namely, a pitch number of containing and contained threads cohered by the effectively bidirectional jointing, i.e., effectively bidirectional contact of the bidirectional tapered internal thread 6 and the traditional external thread 9 is designed according to application conditions. Through the containment of the special tapered body 7 of the traditional external thread 9 by the tapered hole 4, by virtue of positioning in multiple directions such as radial, axial, angular and circumferential, a special combining technology of the cone pair and the thread pair is constituted, which ensures the precision, efficiency and reliability of the transmission connection of the tapered thread technology and especially the bidirectional tapered internal thread and traditional thread.

When the bidirectional tapered internal thread and traditional thread is tightly connected and hermetically connected, technical performances thereof are realized through the screwing connection of the bidirectional tapered hole 41 and the special tapered body 7 of the traditional external thread 9, namely, the technical performances are realized through sizing of the first helical conical surface 421 of the tapered hole and the special conical surface 72 of the special tapered body 7 of the traditional external thread 9 till interference and/or sizing of the second helical conical surface 422 of the tapered hole and the special conical surface 72 of the special tapered body 7 of the traditional external thread 9 till interference. According to application conditions, one direction bears the load and/or two directions simultaneously bear the load respectively. Namely, under the guidance of the helical line, an outer diameter of an internal cone of the bidirectional tapered hole 41 of the bidirectional tapered internal thread 6 and an inner diameter of an external cone of the special tapered body 7 of the traditional external thread 9 are centered till the first helical conical surface 421 of the tapered hole and the special conical surface 72 of the special tapered body 7 of the traditional external thread 9 are cohered till interference contact and/or the second helical conical surface 422 of the tapered hole and the special conical surface 72 of the special tapered body 7 of the traditional external thread 9 are cohered till interference contact, thereby realizing technical performances such as connection, locking, anti-loosening, bearing, fatigue and sealing of mechanical structures.

Therefore, the technical performances such as the transmission precision and efficiency, the load bearing capacity, the locking force of self-locking, the anti-loosening ability, the sealing performance and the reusability of the bidirectional tapered internal thread and traditional thread are related to the sizes of the first helical conical surface 421 of the tapered hole and the formed left taper 95, i.e., the first taper angle α1, and the second helical conical surface 422 of the tapered hole and the formed right taper 96, i.e., the second taper angle α2, and are also related to the sizes of the special conical surface 72 of the special tapered body 7 of the traditional external thread 9 formed by the traditional external thread 9 due to contact with the bidirectional tapered internal thread 6 and the taper of the special conical surface 72. Material friction coefficient, processing quality and application conditions of the columnar body 3 and the cylindrical body 2 also have a certain impact on the cone fit.

In the bidirectional tapered internal thread and traditional thread, when the right-angled trapezoid union rotates a circle at a constant speed, an axial movement distance of the right-angled trapezoid union is at least double a length of the sum of the right-angled sides of the two identical right-angled trapezoids. This structure ensures that the first helical conical surface 421 of the tapered hole and the second helical conical surface 422 of the tapered hole have sufficient length, thus ensuring sufficient effective contact area and intensity as well as efficiency when the conical surface 42 of the bidirectional tapered hole is fitted with the special conical surface 72 of the special tapered body 7 of the traditional external thread 9.

In the bidirectional tapered internal thread and traditional thread, when the right-angled trapezoid union rotates a circle at a constant speed, an axial movement distance of the right-angled trapezoid union is equal to a length of the sum of the right-angled sides of the two identical right-angled trapezoids. This structure ensures that the first helical conical surface 421 of the tapered hole and the second helical conical surface 422 of the tapered hole have sufficient length, thus ensuring sufficient effective contact area and intensity as well as efficiency when the conical surface 42 of the bidirectional tapered hole is fitted with the special conical surface 72 of the special tapered body 7 of the traditional external thread 9.

In the bidirectional tapered internal thread and traditional thread, the first helical conical surface 421 of the tapered hole and the second helical conical surface 422 of the tapered hole are continuous helical surfaces or discontinuous helical surfaces.

In the bidirectional tapered internal thread and traditional thread, one end and/or two ends of the columnar body 3 may be used as a screw-in end screwed into a connecting hole of the cylindrical body 2.

In the bidirectional tapered internal thread and traditional thread, the connecting hole is a threaded hole arranged on the nut body 21.

Compared with the prior art, the connection pair 10 of the bidirectional tapered internal thread and the traditional thread has the advantages of reasonable design, simple structure, convenient operation, large locking force, high bearing capacity, excellent anti-loosening performance, high transmission efficiency and precision, good mechanical sealing effect and good stability, realizes the fastening and connecting functions through sizing of the cone pair formed by the internal cone and the external cone till interference fit, can prevent loosening phenomenon during connection, and has self-locking and self-positioning functions.

### Embodiment 2

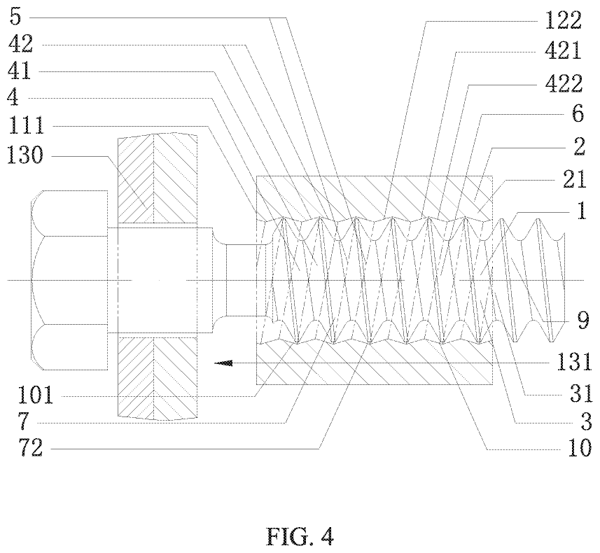

As shown in FIG. 4, the structure, principle and implementation steps of the embodiment are similar to that in Embodiment 1, and the differences are that a connection structure of double nuts of the symmetrical bidirectional tapered internal thread 6 and a bolt of the traditional external thread 9 is adopted in the embodiment. The cylindrical body 2 comprises double nuts, i.e., comprises the nut body 21 and a nut body 22. The nut body 21 is located at a left side of the fastened workpiece 130, while the nut body 22 is located at a right side of the fastened workpiece 130. When the connection structure of the bolt and the double nuts of the embodiment is working, a relationship with the fastened workpiece 130 is also rigid connection. The rigid connection means that an end surface bearing surface of the nut and a bearing surface of the workpiece 130 are mutually bearing surfaces, comprising a bearing surface 111 and a locking bearing surface 112. The workpiece 130 refers to a connected object comprising the workpiece 130.

Working bearing surfaces of the internal thread 6 of the embodiment are different, comprising a tapered thread bearing surface 121 and a tapered thread bearing surface 122. When the cylindrical body 2 is located at a left side of the fastened workpiece 130, i.e., a left end surface of the fastened workpiece 130, and a right end surface of the cylindrical body 2 (i.e., the left nut body) 21 serves as the locking bearing surface 111 between the left nut body 21 and the fastened workpiece 130, a left helical conical surface of a bidirectional tapered thread 1 of the left nut body 21 serves as the working bearing surface of the thread. Namely, the first helical conical surface 421 of the tapered hole and the special conical surface 72 of the traditional external thread 9 are the tapered thread bearing surface 122; and the first helical conical surface 421 of the tapered hole and the special conical surface 72 of the traditional external thread 9 are mutually bearing surfaces. When the cylindrical body 2 is located at a right side of the fastened workpiece 130, i.e., a right end surface of the fastened workpiece 130, and a left end surface of the cylindrical body 2 (i.e., the right nut body 22) serves as the locking bearing surface between the right nut body 22 and the fastened workpiece 130, a right helical conical surface of the bidirectional tapered thread 1 of the right nut body 22 serves as the working bearing surface of the thread. Namely, the second helical conical surface 422 of the tapered hole and the special conical surface 72 of the traditional external thread 9 are the tapered thread bearing surface 121; and the second helical conical surface 422 of the tapered hole and the special conical surface 72 of the traditional external thread 9 are mutually bearing surfaces.

The connecting holes are arranged in the nut body 21 and in the nut body 22.

### Embodiment 3

As shown in FIG. 4, the structure, principle and implementation steps of the embodiment are similar to that in Embodiment 1 and Embodiment 2, and the differences are that a connection structure of a bolt of the traditional thread and a single nut of the symmetrical bidirectional tapered thread 1 is adopted in the embodiment and a bolt body has a hexagon head greater than the screw body 31. When the hexagon head of the bolt is located at a left side, the cylindrical body 2, i.e., the nut body 21, i.e., the single nut is located at the right side of the fastened workpiece 130. When the connection structure of the bolt and the single nut of the embodiment is working, a relationship with the fastened workpiece 130 is also rigid connection. The rigid connection means that the end surface of the nut body 21 and the opposite end surface of the workpiece 130 are mutually bearing surfaces. The bearing surface is the locking bearing surface 111, and the workpiece 130 refers to a connected object comprising the workpiece 130.

The working bearing surface of the internal thread 6 of the embodiment is the tapered thread bearing surface 122, i.e., the cylindrical body 2, i.e., the nut body 21, i.e., the single nut is located at the right side of the fastened workpiece 130. When the connection structure of the bolt and the signal nut is working, a right end surface of the workpiece 130 and a left end surface of the nut body 21 serve as the locking bearing surface 111 between the nut body 21 and the fastened workpiece 130. A right helical conical surface of the bidirectional tapered thread 1 of the nut body 21 is the working bearing surface of the thread, i.e., the second helical conical surface 422 of the tapered hole of the tapered internal thread 6 and the special conical surface 72 of the traditional external thread 9 are the tapered thread bearing surface 122; and the second helical conical surface 422 of the tapered hole and the special conical surface 72 of the traditional external thread 9 are mutually bearing surfaces.

In the embodiment, when the hexagon head of the bolt is located in the right side, the structure, principle and implementation steps thereof are similar to that in Embodiment 1 and Embodiment 2.

### Embodiment 4

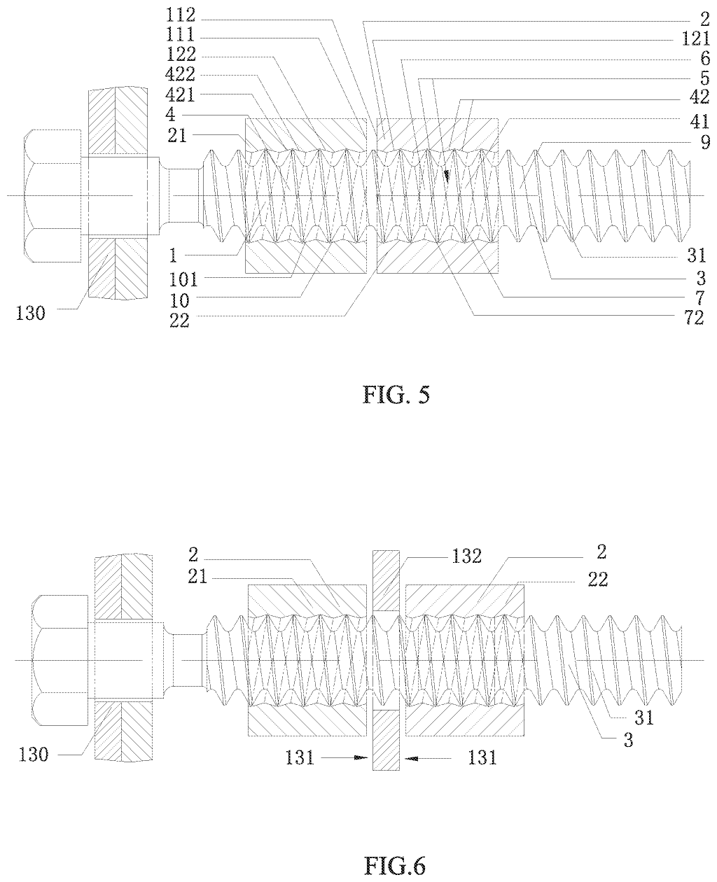

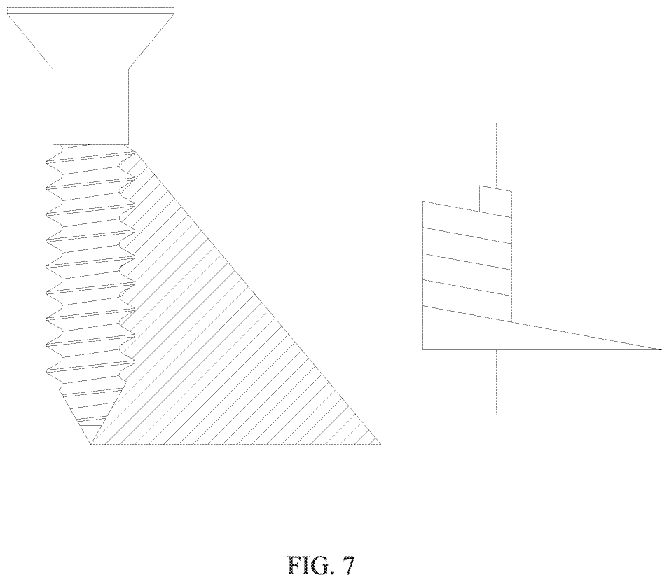

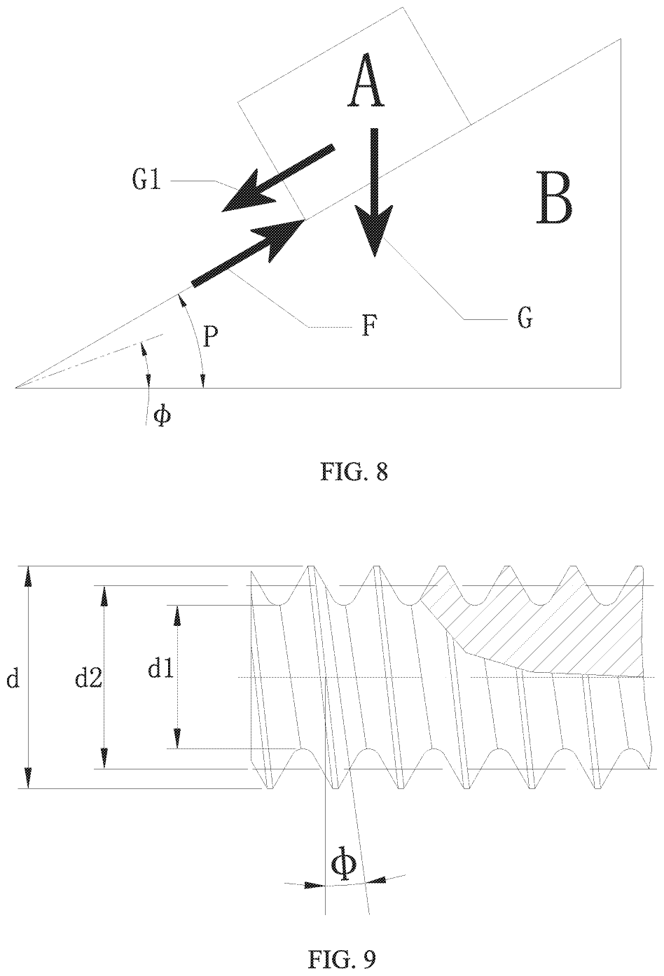

As shown in FIG. 5, the structure, principle and implementation steps of the embodiment are similar to that in Embodiment 1 and Embodiment 2, and the differences are that a positional relationship between the double nuts and the fastened workpiece 130 is different. The double nuts comprise the nut body 21 and the nut body 22, and the bolt body has a hexagon head greater than the screw body 31. When the hexagon head of the bolt is located at a left side, both the nut body 21 and the nut body 22 are located at the right side of the fastened workpiece 130. When the connection structure of the bolt and the double nuts is working, a relationship between the nut body 21 and the nut body 22 with the fastened workpiece 130 is non-rigid connection. The non-rigid connection means that opposite side end surfaces of the nut body 21 and the nut body 22 are mutually bearing surfaces. The bearing surfaces comprise the locking bearing surface 111 and the locking bearing surface 112. The non-rigid connection is mainly applied to non-rigid materials or non-rigid connection workpieces 130 such as transmission pieces and other application fields that need to be installed through double nuts to satisfy requirements, etc. The workpiece 130 refers to a connected object comprising the workpiece 130.

Working bearing surfaces of the internal thread 6 of the embodiment are different, comprising the tapered thread bearing surface 121 and the tapered thread bearing surface 122. When the cylindrical body 2 comprises the left nut body 21 and the right nut body 22, a right end surface of the left nut body 21, i.e., the locking bearing surface 111 and a left end surface of the right nut body 22, i.e., the locking bearing surface 112 are oppositely and directly connected and are mutually locking bearing surfaces. When the right end surface of the left nut body 21 is the locking bearing surface 111, the left helical conical surface of the bidirectional tapered thread 1 of the left nut body 21 serves as the working bearing surface of the thread. Namely, the first helical conical surface 421 of the tapered hole of the tapered internal thread 6 and the special conical surface 72 of the traditional external thread 9 are the tapered thread bearing surface 122; and the first helical conical surface 421 of the tapered hole and the special conical surface 72 of the traditional external thread 9 are mutually bearing surfaces. When the left end surface of the right nut body 22 is the locking bearing surface 112, the right helical conical surface of the bidirectional tapered thread 1 of the right nut body 22 serves the working bearing surface of the thread. Namely, the second helical conical surface 422 of the tapered hole of the tapered internal thread 6 and the special conical surface 72 of the traditional external thread 9 are the tapered thread bearing surface 121; and the second helical conical surface 422 of the tapered hole and the special conical surface 72 of the traditional external thread 9 are mutually bearing surfaces.

In the embodiment, when the cylindrical body 2 located inside, i.e., the nut body 21 adjacent with the fastened workpiece 130 is already effectively combined together with the columnar body 3 (i.e., screw body 31), i.e., the bolt, namely, the internal thread 6 and the external thread 9 forming the thread connection pair 10 are effectively cohered together, the cylindrical body 2 located outside, i.e., the nut body 22 not adjacent with the fastened workpiece 130 may keep an original situation and/or be dismounted with one nut (for example, such application fields having lightweight requirements on equipment or not needing double nuts to ensure the reliability of the connection technology) according to application conditions. The dismounted nut body 22 is not used as a connection nut, but only used as an installation process nut. An internal thread of the installation process nut is not only manufactured by adopting bidirectional tapered threads 6, and may also be a nut body 22 made of unidirectional tapered threads and other threads that can be screwed with the tapered threads, i.e., threads comprising triangular threads, trapezoidal threads, sawtooth threads and other non-tapered threads, but are not limited to the above threads. On the premise of ensuring the reliability of the connection technology, the thread connection pair 10 is a closed-loop fastening technical system, namely, after the internal thread 6 and the external thread 9 of the thread connection pair 10 are effectively cohered together, the thread connection pair 10 will become an independent technical system without relying on technical compensations from a third party to ensure the technical effectiveness of the connection technical system. The effectiveness of the thread connection pair 10 will not be affected even without the support of other objects and even if there is a gap between the thread connection pair 10 and the fastened workpiece 130. This will greatly reduce the weight of the equipment, remove invalid loads, and improve the technical requirements on an effective loading capability, braking performance, and energy conservation and emission reduction of the equipment, which is a unique thread technical advantage no matter the relationship between the thread connection pair 10 of the connection structure of the bidirectional tapered internal thread and the traditional thread and the fastened workpiece 130 is non-rigid connection or rigid connection, and is not possessed by other thread technologies.

In the embodiment, when the hexagon head of the bolt is located at the right side, then both the nut body 21 and the nut body 22 are located at the left side of the fastened workpiece 130, and the structure, principle and implementation steps thereof are similar to that in Embodiment 1 and Embodiment 2.

### Embodiment 5

As shown in FIG. 6, the structure, principle and implementation steps of the embodiment are similar to that in Embodiment 1 and Embodiment 4, and the differences are that the embodiment is additionally provided with a spacer such as a gasket 132 between the nut body 21 and the nut body 22 on the basis of Embodiment 4. That is, the right end surface of the left nut body 21 and the left end surface of the right nut body 22 are oppositely and indirectly contacted through the gasket 132, and thus serve as mutually locking bearing surfaces indirectly. In other words, a relationship between the right end surface of the left nut body 21 and the left end surface of the right nut body 22 is changed from the mutually locking bearing surfaces directly to the locking bearing surface indirectly.

The specific embodiments described herein are merely examples to illustrate the spirit of the present invention. Those skilled in the art of the present invention can make various modifications or supplements to the specific embodiments described or substitute with similar modes without deviating from the spirit of the present invention or going beyond the scope defined by the appended claims.

The terms such as tapered thread 1, cylindrical body 2, nut body 21, nut body 22, columnar body 3, screw body 31, tapered hole 4, bidirectional tapered hole 41, helical conical surface 42 of the tapered hole, first helical conical surface 421 of the tapered hole, first taper angle α1, second helical conical surface 422 of the tapered hole, second taper angle α2, internal helical line 5, internal thread 6, special tapered body 7, special conical surface 72, external thread 9, dumbbell-like shape 94, left taper 95, right taper 96, left-direction distribution 97, right-direction distribution 98, thread connection pair and/or thread pair 10, clearance 101, self-locking force, self-locking, self-positioning, pressure, cone axis 01, thread axis 02, mirror image, shaft sleeve, shaft, single tapered body, double tapered body, cone body, internal cone body, tapered hole, external cone body, tapered body, cone pair, helical structure, helical movement, thread body, complete unit thread, axial force, axial force angle, counter-axial force, counter-axial force angle, centripetal force, counter-centripetal force, inversely collinear, internal stress, bidirectional force, unidirectional force, sliding bearing, sliding bearing pair, locking bearing surface 111, locking bearing surface 112, tapered thread bearing surface 122, tapered thread bearing surface 121, non-entity space, material entity, workpiece 130, nut body locking direction 131, non-rigid connection, non-rigid material, transmission part and gasket 132 are widely used, but the possibility of using other terms is not excluded. These terms are merely used to describe and explain the essence of the present invention more conveniently; and it is contrary to the spirit of the present invention to interpret the terms as any additional limitation.

We claim:

1. A connection structure of an internal thread of a dumbbell-like shaped symmetrical bidirectional tapered thread and a traditional thread, comprising an external thread (9) and an internal thread (6) in mutual thread fit, wherein:
a complete unit thread of the dumbbell-like shaped symmetrical bidirectional tapered internal thread (6) is a helical dumbbell-like shaped symmetrical bidirectional tapered hole (41) small in the middle and large in both ends;
a thread body of the internal thread (6) is the helical bidirectional tapered hole (41) on an inner surface of a cylindrical body (2), and exists in a form of a “non-entity space”;
a thread body of the external thread (9) is a helical special tapered body (7) on an outer surface of a columnar body (3) formed by a tooth body of the original traditional external thread (9) which is assimilated by the bidirectional tapered internal thread (6) due to cohesive contact with the bidirectional tapered internal thread (6), and exists in a form of a “material entity”;
a left taper (95) is formed on a left conical surface of the symmetrical bidirectional tapered internal thread (6) and corresponds to a first taper angle (α1), and a right taper (96) is formed on a right conical surface of the symmetrical bidirectional tapered internal thread (6) and corresponds to a second taper angle (α2);
the left taper (95) and the right taper (96) have opposite directions, and same and/or approximately same tapers; and
the internal thread (6) and the external thread (9) contain the special tapered body by the bidirectional tapered hole till an inner conical surface of the bidirectional tapered hole and an outer conical surface of the special tapered body bear each other.

2. The connection structure according to claim 1, wherein the dumbbell-like shaped bidirectional tapered internal thread (6) comprises a first helical conical surface (421) of the bidirectional tapered hole, a second helical conical surface (422) of the tapered hole, and an internal helical line (5); and
a shape formed by the first helical conical surface (421) of the tapered hole and the second helical conical surface (422) of the tapered hole is the same as a shape of a helical outer flank of a rotating body, wherein the rotating body is formed by two hypotenuses of a right-angled trapezoid union being rotated around a right-angled side of the right-angled trapezoid union, and, at the same time, the right-angled trapezoid union axially moves at a constant speed along a central axis of the cylindrical body (2); wherein the right-angled trapezoid union is formed by oppositely jointing symmetrical upper sides of two identical right-angled trapezoids; and the two right-trapezoids are coincident with the central axis of the cylindrical body (2).

3. The connection structure according to claim 2, wherein when the right-angled trapezoid union rotates a circle at a constant speed, an axial movement distance of the right-angled trapezoid union is at least double a length of the sum of the right-angled sides of the two right-angled trapezoids of the right-angled trapezoid union.

4. The connection structure according to claim 2, wherein when the right-angled trapezoid union rotates a circle at a constant speed, an axial movement distance of the right-angled trapezoid union is equal to a length of the sum of the right-angled sides of the two right-angled trapezoids of the right-angled trapezoid union.

5. The connection structure according to claim 2, wherein the first helical conical surface (421) of the tapered hole, the second helical conical surface (422) of the tapered hole, and the internal helical line (5) are continuous helical surfaces or discontinuous helical surfaces; and
the special tapered body (7) has a special conical surface (72) and the special conical surface (72) is a continuous helical surface or discontinuous helical surface.

6. The connection structure according to claim 1, wherein the internal thread (6) is formed by oppositely jointing symmetrical upper sides of two identical tapered holes (4), wherein lower sides of the two tapered holes are located at two ends of the bidirectional tapered hole (41) and are respectively jointed with lower sides of the adjacent bidirectional tapered hole (41).

7. The connection structure according to claim 1, wherein the traditional thread comprises any one of a triangular thread, a traditional thread, a sawtooth thread, a rectangular thread and an arc thread.

8. The connection structure according to claim 1, wherein:
the bidirectional tapered internal thread (6) has an ability to assimilate the traditional external thread (9); and a single-pitch thread body of the bidirectional tapered internal thread (6) is an incomplete tapered geometry;
the traditional external thread (9) assimilated by the bidirectional tapered internal thread (6) is an assimilated traditional thread; in other words, a thread body of the assimilated traditional external thread (9) is a special form of tapered thread (1);
the internal thread (6) and the external thread (9) form a thread pair (10);
the thread pair (10) is formed by a plurality of cone pairs; and each of the cone pair is formed by the helical bidirectional tapered hole (41) and the helical special tapered body (7) in mutual fit; and
a contact surface between the special conical surface (72) and the first helical conical surface (421) of the tapered hole and a contact surface between the special conical surface (72) and the second helical conical surface (422) of the tapered hole are used as bearing surfaces; an outer diameter of an internal cone and an inner diameter of an external cone are centered under the guidance of the helical line till the first helical conical surface (421) of the tapered hole and the second helical conical surface (422) of the tapered hole are cohered with the special conical surface (72) till the helical conical surface bears a load in one direction and/or the helical conical surface bears the load in two directions and/or till self-positioning generated by self-positioning contact and/or interference contact.

9. The connection structure according to claim 1, wherein when one cylindrical body (2) is combined with the columnar body (3), and the other cylindrical body (2) is capable of being removed and/or kept; the removed cylindrical body (2) is used as an installation process nut, and an internal thread of the installation process nut comprises the bidirectional tapered thread (1), and the removed cylindrical body (2) is also capable of being manufactured by a unidirectional tapered thread and a traditional thread that are capable of being screwed with the columnar body (3).

10. The connection structure according to claim 1, wherein the cylindrical body (2) comprises cylindrical and/or non-cylindrical workpieces and objects which need to be machined with the bidirectional tapered internal threads (6) on inner surfaces thereof, and the inner surfaces comprise geometric shapes of inner surfaces such as cylindrical surfaces and/or non-cylindrical surfaces such as conical surfaces.

11. The connection structure according to claim 1, wherein when the left taper (95) is same as and/or approximately same as the right taper (96), the first taper angle (α1) is greater than 0° and smaller than 53°, and the second taper angle (α2) is greater than 0° and smaller than 53°; and/or, the first taper angle (α1) is greater than or equal to 53° and smaller than 180°, and the second taper angle (α2) is greater than or equal to 53° and smaller than 180°.
